(19) United States
(12) Patent Application Publication
(10) Pub. No.: US 2011/0264528 A1
(43) Pub. Date: Oct. 27, 2011

(54) CONTEXTUAL RECOMMENDATIONS THROUGH PROPOSED ACTIONS

(76) Inventor: Peter WHALE, Cambridge (GB)

(21) Appl. No.: 12/767,771

(22) Filed: Apr. 26, 2010

(51) Int. Cl. G06Q 99/00; G06F 3/048; G06F 15/16; G06Q 30/00

(52) U.S. Cl. 705/14.58; 705/14.64; 705/14.66; 705/319; 705/347; 715/753; 709/206

(57) ABSTRACT

Knowledge of a user's profile (contextual and behavioral) can be used to predict the likely current real-time needs of the user. Confirmation of that need can be achieved by suggesting a number of personalized status updates (based on known profile information) in a form suitable for posting to micro-blogging sites. From this list, the user selects the most appropriate one to submit to a micro-blog. In doing so, valuable profile information is confirmed which allows real-time contextual recommendations to be generated to meet the recently identified need of the user. In one aspect, these recommendations comprise revenue generating opportunities.

### BACKGROUND

The present disclosure relates to a mobile operating environment, and more particularly, to providing improved methods of generating recommendations to users of a mobile device.

Mobile operators or mobile device carriers play a major part in the telecommunication industry today. Initially, such mobile operators concentrated their efforts on generating revenue by increasing their subscriber base. However, it will be appreciated that in several countries, the scope for increasing the subscriber base has now become very limited, as the market has reached close to saturation point. As a result, the mobile operators have been branching out to provide value added services to subscribers, in order to increase their revenue.

One means of generating increased revenue is through the sales of premium services to users, such as ringtones, wallpaper, games, widgets and Java games, etc. These services may be provided by the mobile operator themselves, or by business entities who may operate in collaboration with the mobile operators to provide such services. The services may be available for download to a user's mobile device upon payment of a fee.

Many benefits such as maximizing the potential earnings for sales accrue upon recommending and promoting to users content or services that are most likely to be of interest to the users. The user can have a better experience using their mobile device in light of these individually recommended content and services.

However, providing helpful suggestions to a user of a mobile device can be thwarted by how mobile devices are used. For example, a number of users can use the same mobile device, each user having different preferences and interests. As another example, a user can make a limited number of purchases or interactions from which to derive recommendations for future transactions. As an additional aspect, soliciting user inputs to improve recommendations can prove tedious or intrusive to some users, who thus would refuse to participate.

### SUMMARY

The following presents a simplified summary of one or more aspects in order to provide a basic understanding of such aspects. This summary is not an extensive overview of all contemplated aspects, and is intended to neither identify key or critical elements of all aspects nor delineate the scope of any or all aspects. Its sole purpose is to present some concepts of one or more aspects in a simplified form as a prelude to the more detailed description that is presented later.

In accordance with one or more aspects and corresponding disclosure thereof, various aspects are described in connection with facilitating automatic or manual social network status postings (“micro-blogging”). In particular, by determining a context of a user of a user device, suggestions can be made for such a posting as well as related opportunities for presenting revenue-generating offers based upon these micro-blogging instances.

In one aspect, a method is provided for recommending an action to a user by determining a human context corresponding to a user of a user device, proposing a recommended action based on the human context, receiving a response to the recommended action, and communicating information based upon the response.

In another aspect, a computer program product including a computer-readable medium for recommending an action to a user is provided. The computer-readable storage medium comprises at least one instruction for causing a computer to determine a human context corresponding to a user of a user device. At least one instruction causes the computer to propose a recommended action based on the human context. At least one instruction causes the computer to receive a response to the recommended action. At least one instruction causes the computer to communicate information based upon the response.

In an additional aspect, an apparatus is provided for recommending an action to a user. Means are provided for determining a human context corresponding to a user of a user device. Means are provided for proposing a recommended action based on the human context. Means are provided for receiving a response to the recommended action. Means are provided for communicating information based upon the response.

In another additional aspect, at least one processor is provided for recommending an action to a user. A module determines a human context corresponding to a user of a portable user device. A module transmits to the portable user device to prompt proposing a recommended action based on the human context. A module receives a report from the portable user device based upon a response to the recommended action. A module communicates information based upon the response.

In a further aspect, an apparatus is provided for recommending an action to a user. A computing platform determines a human context corresponding to a user of a user device and proposes a recommended action based on the human context. A user interface receives a response from the user to the context message. A network interface communicates information based upon the response.

In yet one aspect, a method is provided for recommending an action to a user by determining a human context corresponding to a user of a portable user device, transmitting data to the portable user device to prompt proposing a recommended action based on the human context, receiving a report from the portable user device based upon a response to the recommended action, and communicating information based upon the response.

In yet another aspect, a computer program product including a computer-readable storage medium for recommending an action to a user is provided for. The computer-readable storage medium comprises at least one instruction for causing a computer to determine a human context corresponding to a user of a portable user device. At least one instruction causes the computer to transmit data to the portable user device to prompt proposing a recommended action based on the human context. At least one instruction causes the computer to receive a report from the portable user device based upon a response to the recommended action. At least one instruction causes the computer to communicate information based upon the response.

In yet an additional aspect, an apparatus is provided for recommending an action to a user. Means are provided for determining a human context corresponding to a user of a portable user device. Means are provided for transmitting data to the portable user device to prompt proposing a recommended action based on the human context. Means are provided for receiving a report from the portable user device based upon a response to the recommended action. Means are provided for communicating information based upon the response.

In yet another additional aspect, at least one processor is provided for recommending an action to a user. A module determines a human context corresponding to a user of a user device. A module proposes a recommended action based on the human context. A module receives a response to the recommended action. A module communicates information based upon the response.

In yet a further aspect, an apparatus is provided for recommending an action to a user. A computing platform determines a human context corresponding to a user of a portable user device. A transmitter transmits data to the portable user device to prompt proposing a recommended action based on the human context. A receiver receives a report from the portable user device based upon a response to the recommended action. A network interface communicates information based upon the response.

In one aspect, a method is provided for recommending content to a user by determining a human context of a user of a user device, proposing a context message on a user interface of the user device, receiving a response from the user via the user interface to the context message, and communicating a posting to a social network based upon the response.

In another aspect, a computer program product including a computer-readable storage medium for recommending content to a user is provided. The computer-readable storage medium comprises at least one instruction for causing a computer to determine a human context of a user of a user device. Also, at least one instruction causes the computer to propose a context message on a user interface of the user device. Further, at least one instruction causes the computer to receive a response from the user via the user interface to the context message. Additionally, at least one instruction causes the computer to communicate a posting to a social network based upon the response.

In an additional aspect, an apparatus is provided for recommending content to a user. Means are provided for determining a human context of a user of a user device. Means are provided for proposing a context message on a user interface of the user device. Means are provided for receiving a response from the user via the user interface to the context message. Means are provided for communicating a posting to a social network based upon the response.

In a further aspect, an apparatus is provided for recommending content to a user. A computing platform determines a human context of a user of a user device and proposes a context message on the user interface of the user device. The user interface further receives a response from the user to the context message. A network interface communicates a posting to a social network based upon the response.

In yet one aspect, a method is provided for recommending content to a user by determining a human context of a user of a portable user device, transmitting data to the portable user device to prompt proposing a context message on a user interface, receiving a report from the portable user device based upon a response from the user via the user interface to the context message, and communicating a posting to a social network based upon the response.

In yet another aspect, a computer program product is provided for recommending content to a user. A computer-readable storage medium comprises at least one instruction for causing a computer to determine a human context of a user of a portable user device. Also, at least one instruction causes the computer to transmit data to the portable user device to prompt proposing a context message on a user interface. Further, at least one instruction causes the computer to receive a report from the portable user device based upon a response from the user via the user interface to the context message. Additionally, at least one instruction causes the computer to communicate a posting to a social network based upon the response.

In yet an additional aspect, an apparatus is provided for recommending content to a user. Means are provided for determining a human context of a user of a portable user device. Means are provided for transmitting data to the portable user device to prompt proposing a context message on a user interface. Means are provided for receiving a report from the portable user device based upon a response from the user via the user interface to the context message. Means are provided for communicating a posting to a social network based upon the response.

In yet a further aspect, an apparatus is provided for recommending content to a user. A computing platform determines a human context of a user of a portable user device. A transmitter transmits data to the portable user device to prompt proposing a context message on a user interface. A receiver receives a report from the portable user device based upon a response from the user via the user interface to the context message. A network interface communicates a posting to a social network based upon the response.

To the accomplishment of the foregoing and related ends, the one or more aspects comprise the features hereinafter fully described and particularly pointed out in the claims. The following description and the annexed drawings set forth in detail certain illustrative features of the one or more aspects. These features are indicative, however, of but a few of the various ways in which the principles of various aspects may be employed, and this description is intended to include all such aspects and their equivalents.

### BRIEF DESCRIPTION OF THE DRAWINGS

The disclosed aspects will hereinafter be described in conjunction with the appended drawings, provided to illustrate and not to limit the disclosed aspects, wherein like designations denote like elements, and in which:

FIG. 1 illustrates a block diagram for communication network of a user device and a network cooperate in performing harvesting contextual information from users by use of computer-assisted social blogging in order to improve real-time recommendations, according to one aspect.

FIG. 2A illustrates a flow diagram for recommending an action to a user of a user device based upon a human context, according to another aspect.

FIG. 2B illustrates a flow diagram for performing a methodology or sequence of operations for communication network to perform harvesting contextual information from users by use of computer-assisted social blogging in order to improve real-time recommendations, according to another aspect.

FIG. 3 illustrates a flow diagram for a methodology or sequence of operations utilizes profile information and current status determinations for micro-blogging with related transaction offers, according to another aspect.

FIG. 4 illustrates a depiction of a touch screen user interface of a user device, according to another aspect.

FIG. 5 illustrates a block diagram of a distributed system of a server and a client that performs harvesting contextual information from users by use of computer-assisted social blogging in order to improve real-time recommendations, according to another aspect.

FIG. 6 illustrates a block diagram of a distributed recommendation system performed across a wireless communication system, according to another aspect.

FIG. 7 illustrates a block diagram of an exemplary computing environment, according to another aspect.

FIG. 8A illustrates a block diagram for a system such as user equipment for performing automated recommendations for a proposed action by a user of a user device based upon a human context, according to another aspect.

FIG. 8B illustrates a block diagram for a system such as user equipment for performing computer assisted social blogging and receiving recommendations, according to another aspect.

FIG. 9A illustrates a block diagram for a system such as a network entity for performing computer assisted selecting and transmitting recommendations for an action to user equipment based upon human context, according to another aspect.

FIG. 9B illustrates a block diagram for a system such as a network entity for performing computer assisted social blogging and transmitting recommendations to user equipment, according to another aspect.

FIG. 10A illustrates a means for harvesting contextual information from users in order to improve real-time recommendations at a network, according to another aspect.

FIG. 10B illustrates a means for harvesting contextual information from users by use of computer-assisted social blogging in order to improve real-time recommendations at a network, according to another aspect.

FIG. 11A illustrates a means for harvesting contextual information from users to improve real-time recommendations at user equipment, according to another aspect.

FIG. 11B illustrates a means for harvesting contextual information from users by use of computer-assisted social blogging in order to improve real-time recommendations at user equipment, according to another aspect.

### DETAILED DESCRIPTION

User desire for goods and services change with the individual's context or mood (e.g., is the user currently hungry, tired, feeling sociable, in need of entertainment in some down time, has some time to shop, etc.) If a user were able to inform a recommendation system of their context or mood very frequently (e.g., more than once an hour), then such a system could serve more targeted recommendations for goods and services. However the motivation for a user to constantly update their context is low. One problem to be solved, therefore, is ascertaining user context easily with minimal user effort required, in return for the benefit of highly relevant recommendations.

In an exemplary aspect, knowledge of a user's profile (contextual and behavioral) can be used to predict the likely current real-time needs of the user. Confirmation of that need can be achieved by suggesting a number of personalized status updates (based on known profile information) in a form suitable for posting to micro-blogging sites. From this list, the user selects the most appropriate one to submit to a micro-blog. In doing so, valuable profile information is confirmed which allows real-time contextual recommendations to be generated to meet the recently identified need of the user. In one aspect, these recommendations are revenue generating opportunities.

It should be appreciated with the benefit of the present disclosure that a status update to a social network can address a number of scenarios, of which the illustrative micro-blogging for alerting friends, acquaintances, and fans is exemplary. The context of an individual can be influenced by, or as a result of, the context of other individuals or groups. Consequently, a social network can broadly address communications amongst a group of individuals responsive to the human context.

More generically the innovation provides a very convenient method for users who wish to transmit frequently changing information and instructions to other users and to other computer systems, based on information collected by a system on their behalf and processed into recommended actions to follow as a result of analyzing the input data.

So by way of an example, a medical application could be a community doctor who is responsible for the care of a number of out-patients. Each patient has a sensor system attached to them which can report vital signs back to a system, such as heart-rate, blood pressure, etc., and perhaps their location. The system could analyze the sensor data and make suggestions to the doctor such as “Blood pressure of patient X is 10% higher than normal—do you want to arrange to see the patient in surgery this week?” The doctor can make the judgment as to the course of action, and if (s)he accepts the recommendation then the request to book an appointment and notify the patient could be made to an external system.

Various aspects of the disclosure are further described below. It should be apparent that the teaching herein can be embodied in a wide variety of forms and that any specific structure or function disclosed herein is merely representative. Based on the teachings herein one skilled in the art should appreciate that an aspect disclosed herein can be implemented independently of other aspects and that two or more of these aspects can be combined in various ways. For example, an apparatus can be implemented or a method practiced using any number of the aspects set forth herein. In addition, an apparatus can be implemented or a method practiced using other structure or functionality in addition to or other than one or more of the aspects set forth herein. As an example, many of the methods, devices, systems, and apparatus described herein are described in the context of providing dynamic queries and recommendations in a mobile communication environment. One skilled in the art should appreciate that similar techniques could apply to other communication and non-communication environments as well.

As used in this disclosure, the term “content” and “objects” are used to describe any type of application, multimedia file, image file, executable, program, web page, script, document, presentation, message, data, meta-data, or any other type of media or information that may be rendered, processed, or executed on a device.

As used in this disclosure, the terms “component,” “system,” “module,” and the like are intended to refer to a computer-related entity, either hardware, software, software in execution, firmware, middle ware, microcode, or any combination thereof. For example, a component can be, but is not limited to being, a process running on a processor, a processor, an object, an executable, a thread of execution, a program, or a computer. One or more components can reside within a process or thread of execution and a component can be localized on one computer or distributed between two or more computers. Further, these components can execute from various computer readable media having various data structures stored thereon. The components can communicate by way of local or remote processes such as in accordance with a signal having one or more data packets (e.g., data from one component interacting with another component in a local system, distributed system, or across a network such as the Internet with other systems by way of the signal). Additionally, components of systems described herein can be rearranged or complemented by additional components in order to facilitate achieving the various aspects, goals, advantages, etc., described with regard thereto, and are not limited to the precise configurations set forth in a given figure, as will be appreciated by one skilled in the art.

Additionally, the various illustrative logics, logical blocks, modules, and circuits described in connection with the aspects disclosed herein can be implemented or performed with a general purpose processor, a digital signal processor (DSP), an application specific integrated circuit (ASIC), a field programmable gate array (FPGA) or other programmable logic device, discrete gate or transistor logic, discrete hardware components, or any suitable combination thereof designed to perform the functions described herein. A general-purpose processor can be a microprocessor, but, in the alternative, the processor can be any conventional processor, controller, microcontroller, or state machine. A processor can also be implemented as a combination of computing devices, e.g., a combination of a DSP and a microprocessor, a plurality of microprocessors, one or more microprocessors in conjunction with a DSP core, or any other suitable configuration. Additionally, at least one processor can comprise one or more modules operable to perform one or more of the operations or actions described herein.

Moreover, various aspects or features described herein can be implemented as a method, apparatus, or article of manufacture using standard programming or engineering techniques. Further, the operations or actions of a method or algorithm described in connection with the aspects disclosed herein can be embodied directly in hardware, in a software module executed by a processor, or in a combination of the two. Additionally, in some aspects, the operations or actions of a method or algorithm can reside as at least one or any combination or set of codes or instructions on a machine-readable medium or computer readable medium, which can be incorporated into a computer program product. Further, the term “article of manufacture” as used herein is intended to encompass a computer program accessible from any computer-readable device, carrier, or media. For example, computer-readable media can include but are not limited to magnetic storage devices (e.g., hard disk, floppy disk, magnetic strips, etc.), optical disks (e.g., compact disk (CD), digital versatile disk (DVD), etc.), smart cards, and flash memory devices (e.g., card, stick, key drive, etc.). Additionally, various storage media described herein can represent one or more devices or other machine-readable media for storing information. The term “machine-readable medium” can include, without being limited to, wireless channels and various other media capable of storing, containing, or carrying instruction, or data.

Furthermore, various aspects are described herein in connection with a mobile device. A mobile device can also be called a system, a subscriber unit, a subscriber station, mobile station, mobile, mobile device, cellular device, multi-mode device, remote station, remote terminal, access terminal, user terminal, user agent, a user device, or user equipment, or the like. A subscriber station can be a cellular telephone, a cordless telephone, a Session Initiation Protocol (SIP) phone, a wireless local loop (WLL) station, a personal digital assistant (PDA), a handheld device having wireless connection capability, or other processing device connected to a wireless modem or similar mechanism facilitating wireless communication with a processing device.

In addition to the foregoing, the word “exemplary” is used herein to mean serving as an example, instance, or illustration. Any aspect or design described herein as “exemplary” is not necessarily to be construed as preferred or advantageous over other aspects or designs. Rather, use of the word exemplary is intended to present concepts in a concrete fashion. Furthermore, as used in this application and the appended claims, the term “or” is intended to mean an inclusive “or” rather than an exclusive “or.” That is, unless specified otherwise, or clear from context, “X employs A or B” is intended to mean any of the natural inclusive permutations. That is, in this example, X could employ A, or X could employ B, or X could employ both A and B, and thus the statement “X employs A or B” is satisfied under any of the foregoing instances. In addition, the articles “a” and “an” as used in this application and the appended claims should generally be construed to mean “one or more” unless specified otherwise or clear from context to be directed to a singular form.

As used herein, the terms to “infer” or “inference” refer generally to the process of reasoning about or deducing states of a system, environment, or user from a set of observations as captured via events or data. Inference can be employed to identify a specific context or action, or can generate a probability distribution over states, for example. The inference can be probabilistic—that is, the computation of a probability distribution over states of interest based on a consideration of data and events. Inference can also refer to techniques employed for composing higher-level events from a set of events or data. Such inference results in the construction of new events or actions from a set of observed events or stored event data, whether or not the events are correlated in close temporal proximity, and whether the events and data come from one or several event and data sources.

Various aspects are now described with reference to the drawings. In the following description, for purposes of explanation, numerous specific details are set forth in order to provide a thorough understanding of one or more aspects. It may be evident, however, that the various aspects may be practiced without these specific details. In other instances, well-known structures and devices are shown in block diagram form in order to facilitate describing these aspects

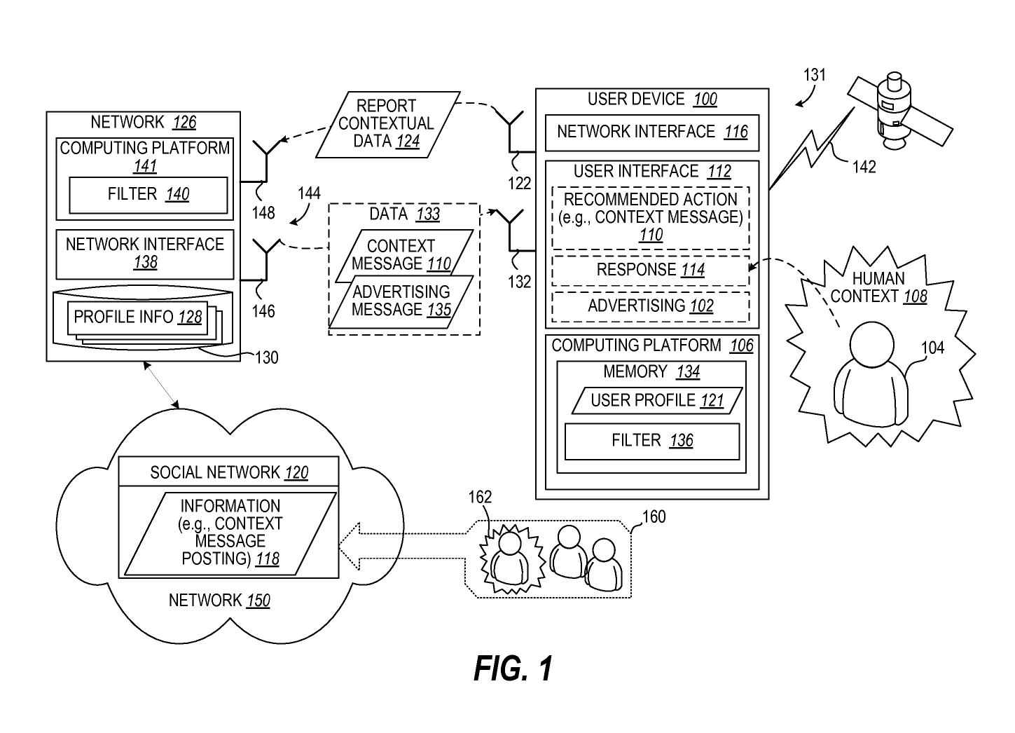

With initial reference to FIG. 1, an apparatus, depicted as a user device 100, recommends content, depicted as an advertised item 102 (e.g., goods or service, media content, etc.) to a user 104. A computing platform 106 determines a human context (e.g., environs, location, mood, perceived need, etc.) 108 of the user 104 of the user device 100 and proposes a recommended action (e.g., context message) 110 on a user interface 112 of the user device 100. In one aspect, a plurality of context messages 110 can be presented for selection. The user interface 112 receives a response (e.g., voice command, touch/key input, acquiescence, manual text input, etc.) 114 from the user 104 to the context message 110. For example, the response 114 can be edited by the user 104 or substituted for another status message in lieu of the automated one. A network interface 116 communicates information (e.g., a posting 118 to a social network 120) based upon the response 114. The computing platform 106 updates a profile 121 of the user 104 based upon the response 114 from the user 104.

In one aspect, the user device 100 is wireless, portable device, having a transmitter 122 that transmits a report of contextual data 124 to a network 126 that maintains profile information 128 of the user 104 remote to the user device 100. In the exemplary aspect, the user device 100 has the locally-available profile 121, such as for a cold-start operation wherein insufficient remote profile information 128 exists, for autonomous operation, or for real-time response in lieu of or in addition to a remote profile repository 130 containing the profile information 128.

In some of these instances, a communication network 131 of the user device 100 and network 126 cooperate in performing harvesting contextual information from users by use of computer-assisted social blogging in order to improve real-time recommendations. The network 126 can transmit data 133 for presenting to the user 104. The data 133 can be sent in advance to pre-provision of the data 133 on the user device 100. Alternatively or in addition, the data 133 can be sent subsequently in response to a detected opportunity. Further, the data 133 can comprise the context message 110. Alternatively or in addition, the data 133 can comprise an advertising message 135. A receiver 132 receives the context message 110 from the network 126 in addition to or as an alternative to locally deriving or accessing what is previously provisioned in computer-readable storage medium (e.g., memory) 134. In another aspect, the receiver 132 receives the advertising item 102 to present to the user 104 via the user interface 112 from the network 126 based upon the remote profile repository 130, context message 110, and the response 114. An objective can be for the advertising item 102 to directly or indirectly address the human context 108. Alternatively, the computing platform 106 can recommend the advertising item 102 related to the human context 108 and the response 114 for the user interface 112 to present.

The computing platform 106 can employ a filter 136 for the posting 118 prior to communicating to the social network 120. For instance, the filter 136 can select a user-designated or an appropriate one of a plurality of social networks 120. The filter 136 can block or edit the context message 110 (e.g., appropriate length, removal of objectionable content, etc.). For example, the filter 136 aligns a topic of a context message 110 to a social network 120 (e.g., dining and personal activities posted on a friend networking site, employment-related posts placed on a professional networking site, etc.). The filter 136 can impose a constraint such as a communication protocol, authentication, type of content, etc., that prompts formatting of the communication.

Alternatively, the network 126 can include a network interface 138 that uses a filter 140 for appropriately communicating with the social network 120. In an exemplary aspect, the computing platform 106 or a computing platform 141 of the network 126 can determine a location of the user device 100 for determining the human context 108, depicted as a satellite position system such as a Global Positioning System (GPS) capability 142. Alternatively, a sector or bearing from a radio access technology can be used, for instance. In some instances, the advertising item 102 can also be based upon location to enhance its suitability.

In an exemplary aspect, the network 126 comprises a Radio Access Network (RAN) 144 having at least one transmitter 146 and at least one receiver 148 that communicates with the user device 100 and provides the network interface 138 that communicates with a terrestrial network 150 that hosts the social network 120.

In a further aspect, third parties 160 can have a corresponding human context 162 associated with the human context 108 of the user 104.

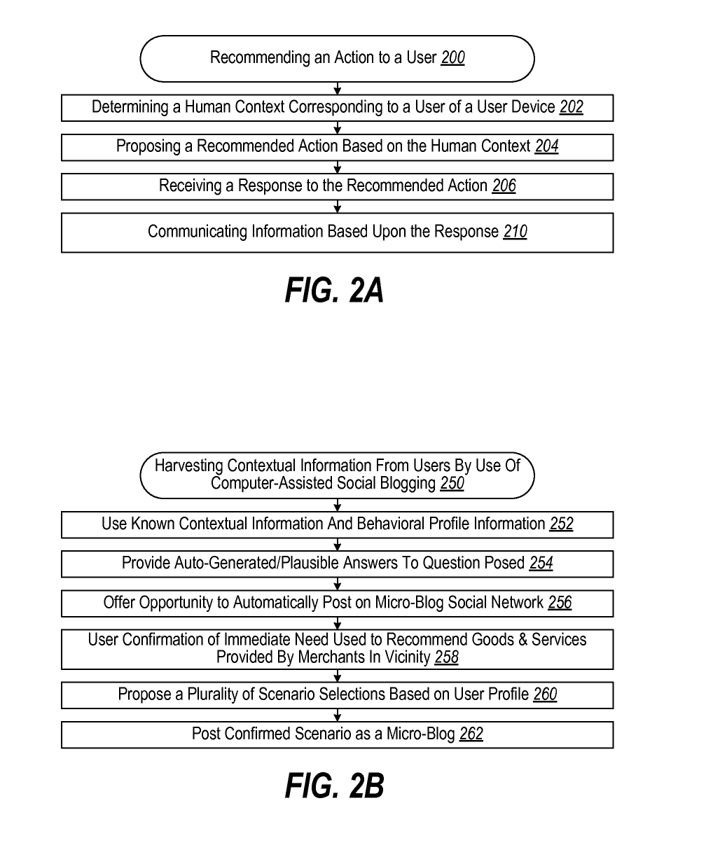

In FIG. 2A, a methodology or sequence of operations 200 is provided for recommending an action to a user. Determining a human context corresponding to a user of a user device is depicted in block 202. Proposing a recommended action based on the human context is depicted in block 204. Receiving a response to the recommended action is depicted in block 206. Communicating information based upon the response is depicted in block 208.

In an exemplary use depicted in FIG. 2B, a methodology or sequence of operations 250 is performed for harvesting contextual information from users by use of computer-assisted social blogging in order to improve real-time recommendations.

At 252, known contextual information and behavioral profile information (location, time of day, schedule etc) is used to pose contextual status questions to the user (e.g., “Getting thirsty?” “Ready for a coffee break?”).

At 254, automatically generated and plausible answers (scenarios) to the question posed are generated, as a method to solicit the actual need or status of the user. These scenarios can be in a personalized form, based on knowledge of the user's profile and suitable for posting to a micro-blogging site (“Mike has been shopping all morning and is ready to stop for a double shot Latte”). In this example, the system would already know that Mike has been shopping through previous contextual or behavioral inputs, and from his profile preferences would know that his favorite type of coffee is a double shot Latte.

At 256, the opportunity to optionally post the selected scenario text to a micro-blogging site as an easy method of maintaining a detailed micro-blog of daily activity is offered. This would otherwise be labor-intensive for the user to maintain. The approach of automatically proposing personalized posts to micro-blogging sites provides benefit to those wishing to maintain a rich micro-blog with minimal effort, but also provides benefit to a recommendation system in surmising the current need of the user.

At 258, the confirmation provided by the user of their status is used as a confirmation of their immediate need or desire and from there goods and services provided either by merchants in the vicinity or by online merchants can be recommended. For instance, the user can confirm being bored and in need of entertainment. In response, an offer is made to download a game, which is selected based upon their interests and profile.

As shown at 260, a subsidiary component of the system is that the system can provide a set of basic options from which the user can select (e.g., “I am hungry,” “I am lost,” “I want to meet a friend”). Then the system can construct a set of alternative scenarios from which the user can easily select an appropriate one. For instance, “I am hungry” could translate into “Mike is ready to find a steak to eat in downtown San Diego” based on knowledge of Mike's current location and food preferences.

As shown at 262, a subsidiary component of the system is that the system can offer to micro-blog the user status at or after the point of transaction. For instance, “Mike is enjoying a double shot Latte at Starbucks in downtown San Diego” or “Mike is pleased to have finally bought a birthday gift for his son,” can provide a viral recommendation capability to Mike's friends.

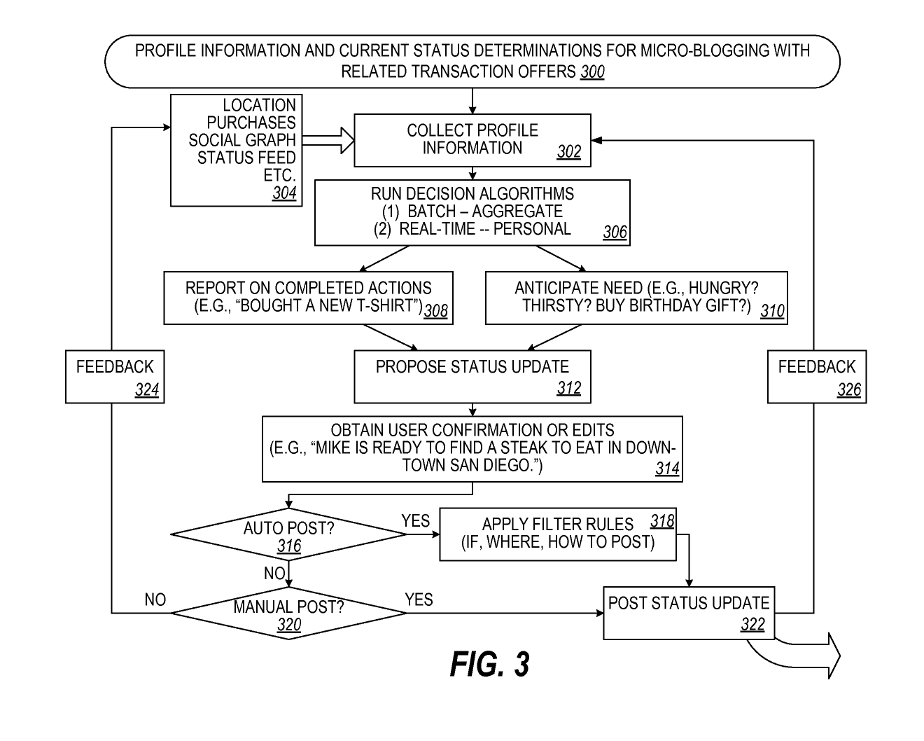

In FIG. 3, a methodology or sequence of operations 300 utilizes profile information and current status determinations for micro-blogging with related transaction offers, according to one aspect. At block 302, profile information is collected. For instance, location, purchases, social graph, status feed, etc., information 304 can be collected. Decision algorithms can be run upon this information (e.g., batch/aggregate, real-time personal, etc.) (block 306). Up-to-date context data can include reporting on completed actions (e.g., bought a new shirt, downloaded a video, etc.), which in some instances can be facilitated by a user device (block 308).

Based upon these algorithms, profile information, current actions, etc., an anticipated need can be provided as a context message via a user interface of the user device to a user (block 310). For example, the context message can be “are you hungry?,” “are you thirsty?”, “need to buy a birthday gift?” (e.g., by referencing friend birthdays on social network and noting location proximate to shopping). Based upon a user confirmation, a status update can be proposed for posting on a micro-blog social network (block 312). The user can confirm one suggestion, select among a plurality of suggestions, or manually input/edit a status update (block 314). In some instances, the context messages can be transmitted to the portable user device to prompt proposing a context message on a user interface, can be pre-provisioned on the portable user device, or determined autonomously at the portable user device.

In block 316, a determination is made that such confirmations should be automatically posted. If so, filtering can be performed prior to posting to communicating to the social network (block 318). For instance, the appropriate social network for receiving the posting is determined. A constraint for communicating the posting to the social network can be accessed in order to appropriately format the posting. Alternatively or subsequently if not an auto post, a determination can be made in block 320 that the micro-blog is to entail a manual post. For instance, a suggested posting could be displayed with an opportunity to revise it or cancel it before sending. Then the status is posted (block 322). For example, the profile information can be updated with feedback 324 based on the user choosing not to post this status, thus updating a weighting for the future regarding whether or not to suggest similar postings. Alternatively or in addition, feedback 326 can be based on what content is posted, even if manually done without prompting from the user device.

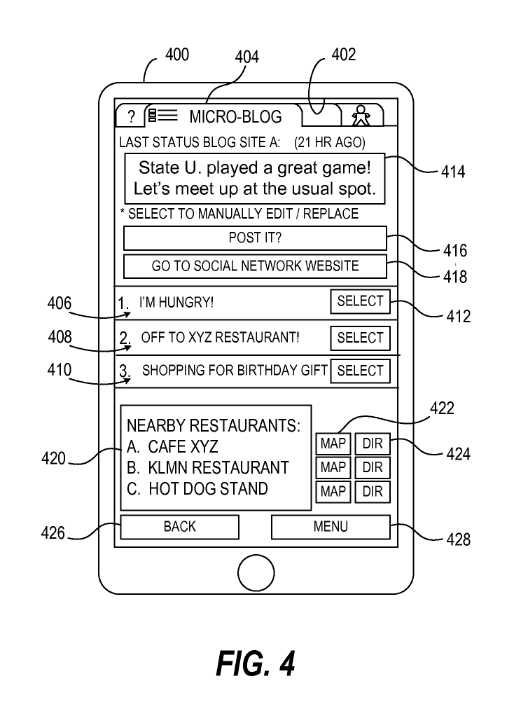

In FIG. 4, an illustrative user device 400 employs a user interface 402, depicted as a touch screen. It should be appreciated with the benefit of the present disclosure that a user interface consistent with one or more aspects of the present disclosure can utilize a combination of graphical, textual, audio, tactile, etc., methods of input and output. To that end, a micro-blog screen 404 has been selected. A plurality of contextual messages has been presented, specifically “1. I'm hungry!” 406, “2. Off to XYZ restaurant” 408, “3. “Shopping for birthday gift” 410. The user can indicate a confirmation or selection, such as by using a “select” soft key 412. Alternatively or in addition, a status text field 414 can be filled in automatically, edited by the user, or manually entered. In some instances, a status is automatically posted or manually posted, such as by selecting “post it” soft key 416. Manual entry can also be performed with the system passively monitoring a user input in order to obtain contextual data, depicted as a “go to social network website” soft key 418.

Offering of goods and services 420 can be coupled with user interactions such as a wireless purchase transaction or by some selection indicating user interest. This is depicted as a map soft key 422 and directions soft key 424.

The user device 400 can be a portable user device, such as smart phone, personal data assistant, gaming device, etc., as suggested by utility controls such as a back soft key 426 and a menu soft key 428.

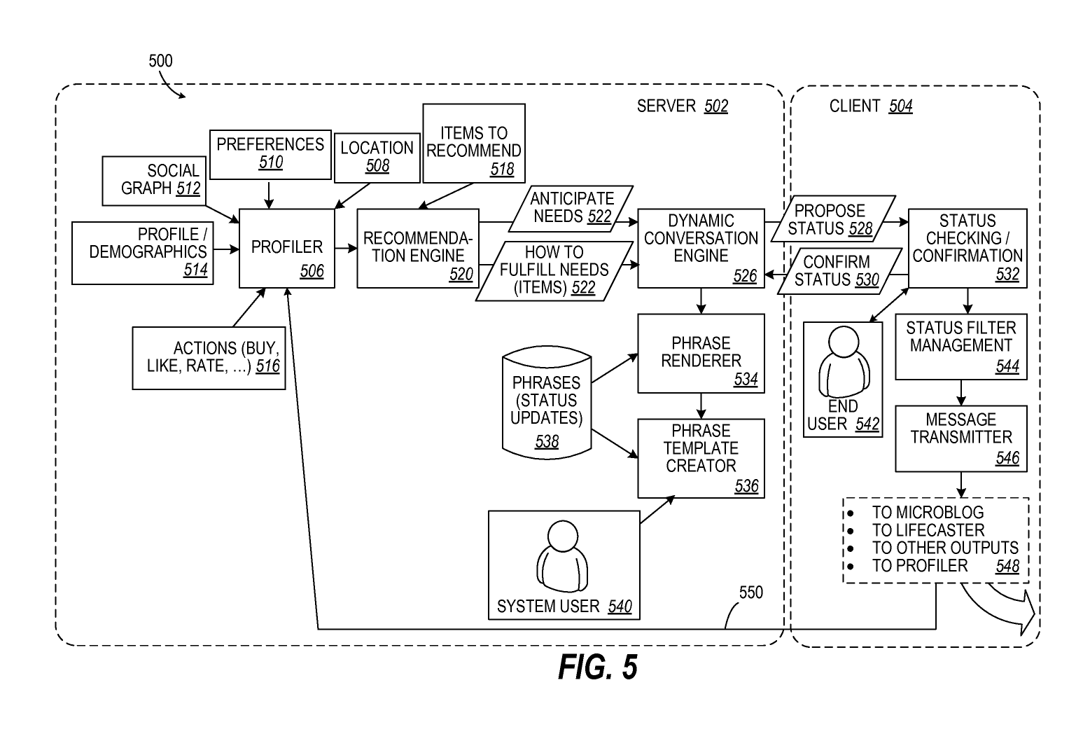

In FIG. 5, a distributed system 500 of a server 502 and a client 504 (e.g., portable user device) performs harvesting contextual information from users by use of computer-assisted social blogging in order to improve real-time recommendations. A profiler 506 receives and maintains information to characterize a user or subscriber, for instance location 508, preferences (e.g., voluntarily submitted, inferred, etc.) 510, social graph 512, profile demographics 514, and actions (e.g., buy, like, rates, etc.) 516. Information from the profile 506 and a catalog 518 of items to recommend is received by a recommendation engine 520. Thereby, outputs are generated, specifically anticipated needs 522 and identified content, goods or services 524 that can fulfill the anticipated needs.

In one aspect, in order to reduce the processing overhead of the client 504, contextual messages can be generated by the server 502. A dynamic conversation engine 526 can transmit a propose status communication 528 and receive a confirm status communication 530 from a status checking/confirmation component 532 of the client 504. On the server side, a phrase renderer 534 and phrase template creator 536 can interact with a repository 538 of phrases (status updates). In one aspect, the phase template creator 536 can be used by an end user 542 rather than a system user 540. In another aspect, the system user 540 can populate phrases using established templates that in turn are rendered for the user interface (not shown) of the client 504.

In one aspect, a template can have a mixture of pre-defined words as well as place-holders for personalized text introduced based upon context For example, a template can say “<PERSON> is <NEED> and ready to <ACTION> <ITEM>” where items in < > are tokens or placeholders to later be replaced with personalized text. When customized in real-time or near real-time based upon a profile for user Mike and current human context, the template can propose a context message, “Mike is thirsty and ready to drink a double-shot Latte.”

On the client side, the end user 542 can confirm or otherwise interact with the propose status 528. The confirmed status 530 is processed by a status filter management component 544 that determines whether or how to post a status as a micro-blog on a social networking site. A message transmitter 546 causes a formatted posting to be directed to the appropriate destination 548 with feedback 550 returned to the server 502 for closed-loop profile updates.

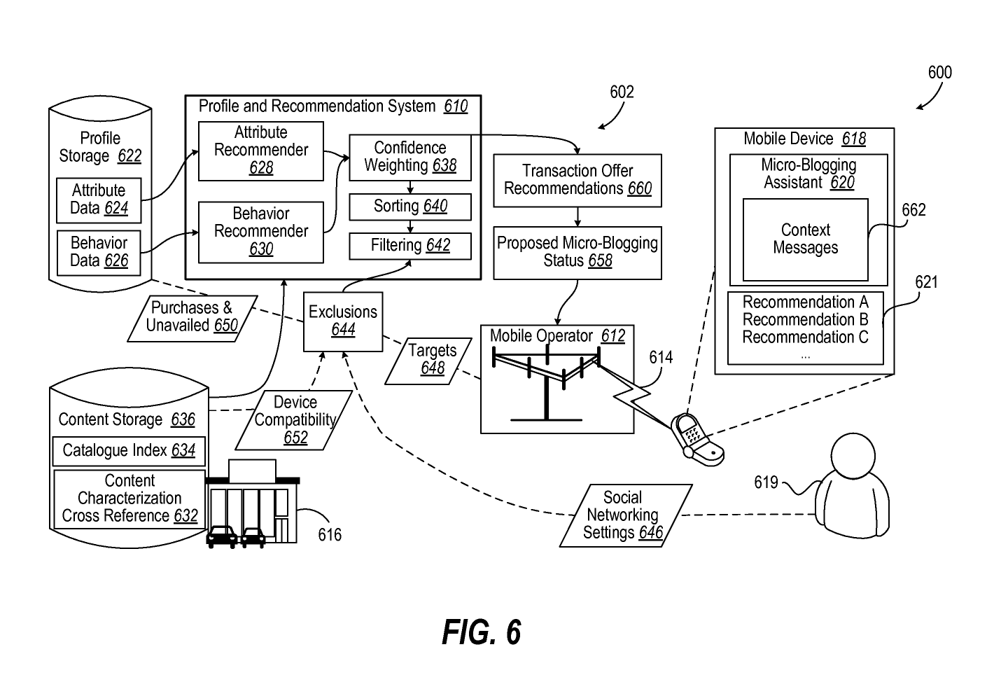

With reference to FIG. 6, in an exemplary aspect, a distributed recommendation system 600 is performed across a wireless communication system 602. In particular, one or more of the present aspects provide a profile and recommendation system 610 that enables mobile operators 612 of a wireless communication network 614 and their business partners, depicted as content providers 616, to proactively promote the uptake of content and services to their subscriber base, depicted as a mobile device 618 of a subscriber 619. In this exemplary implementation, content delivery is enhanced through profiling a user, with micro-blogging being at least one aspect of this profiling. In addition, content delivery can include or be directed to offers for transactions for goods and services as well as for media content usable upon the mobile device 618.

Initially, a micro-blogging assistant 620 is provisioned with recommendations and can autonomously generate queries, or elicit responses to the recommendations as queries, in order to begin or to enhance characterizing the subscriber 619. In one example, this is achieved by the generation of a list of recommendations 621 tailored for the particular subscriber 619 for delivery to their mobile device 618. The recommendations can be displayed either on the portal associated with the mobile operator, or be delivered to the mobile device by mobile messaging, for example.

According to one aspect, stored profile data 622 comprises attribute data 624 or behavior data 626. Examples of attributes could include interests, preferences, affinities, demographics, actual or past location and so on. A corresponding plurality of recommenders, depicted as an attribute recommender 628 and a behavior recommender 630 associate the respective data 624, 626 with content characterization cross reference 632 of a catalogue index 634 of content storage 636. Preliminary recommendations from the recommenders 628, 630 have a confidence level assigned by a confidence weighting component 638. For example, a weak or strong association may be determined. As another example, an attribute or behavior may be weakly determined through inferential analysis of limited occurrences or be strongly determined through explicit inputs or repeated behaviors. The weighted preliminary recommendations can then be sorted by a sorting component 640.

Prior or subsequent to sorting, a filtering component 642 implements an exclusion 644 to avoid an inappropriate recommendation. Exclusions can be expressly specified by the subscriber 619 as depicted at 646, such as restricting certain categories of recommendations that would be objectionable. Exclusions can be specified by the mobile operator 612 as depicted at 648, such as specifying computing platform targets suitable for the content (e.g., audio files suitable for a mobile device with an MP3 media player). Exclusions can also be drawn from profile data 622 depicted at 650, such as tracking of purchases of content that would otherwise be recommended again or recommendations repeatedly ignored by the subscriber 619. Exclusions can also be drawn from content providers 616, which can be the mobile operator 612, by providing device or software configuration compatibility information 652. Thereby, mobile devices 618 that cannot successfully use recommended content are excluded.

The recommendations 621 can be generated by an analysis of the subscriber information available to the mobile operator 612 in conjunction with the content and services offered, so as to determine those content and services, which are likely to be of the most interest to the subscriber. In particular, the profile and recommendation system 610 also enables the recommendations to be delivered to the subscriber 619 at those times which have been determined to be when the subscriber 619 is most amenable to purchasing based on attribute or behavior assessment as an individual or group member. The profile and recommendation system is also adapted to generate promotions, when it is desired to actively promote a particular content or service to its subscriber base.

The exclusion 644, or another portion of the profile and recommendation system 610, can advantageously incorporate the filter component 642 that appropriately facilitates micro-blogging suggestions, profile updating, and recommending related transaction offers (e.g., content, goods, services, etc.). Such actions are depicted as a proposed micro-blogging status component 658 and a transaction offer recommendations component 660. These are depicted as affecting the micro-blogging assistant 620 of the mobile device 618 by presenting context messages 662 and recommendations 621. A user 619 can input social networking settings 646 in order to associate auto or manual micro-blogging with a particular social network as well as related preferences.

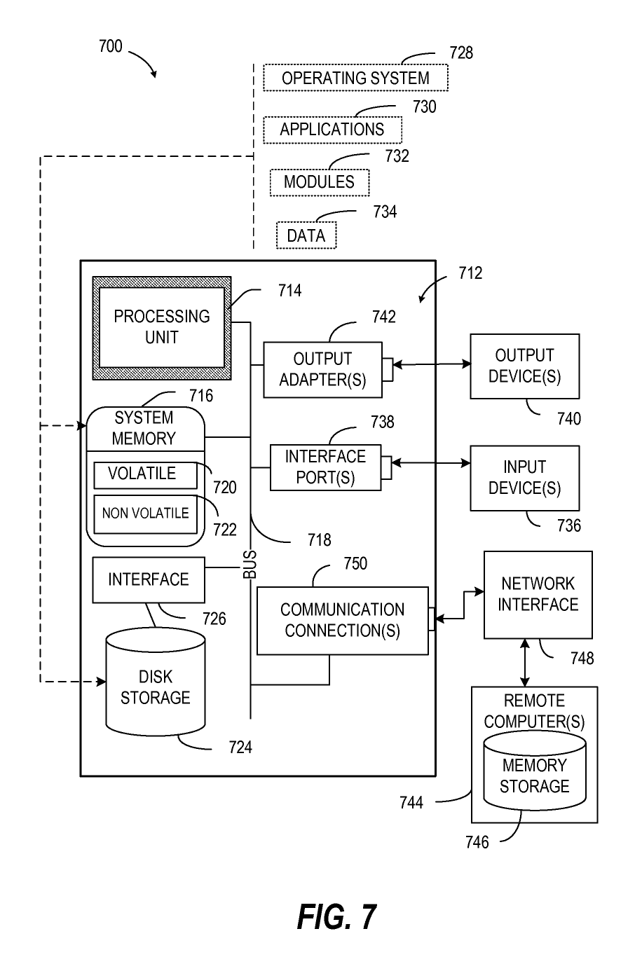

With reference to FIG. 7, an exemplary computing environment 700 for implementing various aspects of the claimed subject matter includes a computer 712. The computer 712 includes a processing unit 714, a system memory 716, and a system bus 718. The system bus 718 couples system components including, but not limited to, the system memory 716 to the processing unit 714. The processing unit 714 can be any of various available processors. Dual microprocessors and other multiprocessor architectures also can be employed as the processing unit 714.

The system bus 718 can be any of several types of bus structure(s) including the memory bus or memory controller, a peripheral bus or external bus, and/or a local bus using any variety of available bus architectures including, but not limited to, Industrial Standard Architecture (ISA), Micro-Channel Architecture (MSA), Extended ISA (EISA), Intelligent Drive Electronics (IDE), VESA Local Bus (VLB), Peripheral Component Interconnect (PCI), Card Bus, Universal Serial Bus (USB), Advanced Graphics Port (AGP), Personal Computer Memory Card International Association bus (PCMCIA), Firewire (IEEE 794), and Small Computer Systems Interface (SCSI).

The system memory 716 includes volatile memory 720 and nonvolatile memory 722. The basic input/output system (BIOS), containing the basic routines to transfer information between elements within the computer 712, such as during start-up, is stored in nonvolatile memory 722. By way of illustration, and not limitation, nonvolatile memory 722 can include read only memory (ROM), programmable ROM (PROM), electrically programmable ROM (EPROM), electrically erasable programmable ROM (EEPROM), or flash memory. Volatile memory 720 includes random access memory (RAM), which acts as external cache memory. By way of illustration and not limitation, RAM is available in many forms such as static RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), Rambus direct RAM (RDRAM), direct Rambus dynamic RAM (DRDRAM), and Rambus dynamic RAM (RDRAM).

Computer 712 also includes removable/non-removable, volatile/non-volatile computer storage media. FIG. 7 illustrates, for example, disk storage 724. Disk storage 724 includes, but is not limited to, devices like a magnetic disk drive, floppy disk drive, tape drive, Jaz drive, Zip drive, LS-100 drive, flash memory card, or memory stick. In addition, disk storage 724 can include storage media separately or in combination with other storage media including, but not limited to, an optical disk drive such as a compact disk ROM device (CD-ROM), CD recordable drive (CD-R Drive), CD rewritable drive (CD-RW Drive) or a digital versatile disk ROM drive (DVD-ROM). To facilitate connection of the disk storage devices 724 to the system bus 718, a removable or non-removable interface is typically used such as interface 726.

It is to be appreciated that FIG. 7 describes software that acts as an intermediary between users and the basic computer resources described in the suitable operating environment 700. Such software includes an operating system 728. Operating system 728, which can be stored on disk storage 724, acts to control and allocate resources of the computer system 712. System applications 730 take advantage of the management of resources by operating system 728 through program modules 732 and program data 734 stored either in system memory 716 or on disk storage 724. It is to be appreciated that the claimed subject matter can be implemented with various operating systems or combinations of operating systems.

A user enters commands or information into the computer 712 through input device(s) 736. Input devices 736 include, but are not limited to, a pointing device such as a mouse, trackball, stylus, touch pad, keyboard, microphone, joystick, game pad, satellite dish, scanner, TV tuner card, digital camera, digital video camera, web camera, and the like. These and other input devices connect to the processing unit 714 through the system bus 718 via interface port(s) 738. Interface port(s) 738 include, for example, a serial port, a parallel port, a game port, and a universal serial bus (USB). Output device(s) 740 use some of the same type of ports as input device(s) 736. Thus, for example, a USB port may be used to provide input to computer 712 and to output information from computer 712 to an output device 740. Output adapter 742 is provided to illustrate that there are some output devices 740 like monitors, speakers, and printers, among other output devices 740, which require special adapters. The output adapters 742 include, by way of illustration and not limitation, video and sound cards that provide a means of connection between the output device 740 and the system bus 718. It should be noted that other devices and/or systems of devices provide both input and output capabilities such as remote computer(s) 744.

Computer 712 can operate in a networked environment using logical connections to one or more remote computers, such as remote computer(s) 744. The remote computer(s) 744 can be a personal computer, a server, a router, a network PC, a workstation, a microprocessor based appliance, a peer device or other common network node and the like, and typically includes many or all of the elements described relative to computer 712. For purposes of brevity, only a memory storage device 746 is illustrated with remote computer(s) 744. Remote computer(s) 744 is logically connected to computer 712 through a network interface 748 and then physically connected via communication connection 750. Network interface 748 encompasses wire and/or wireless communication networks such as local-area networks (LAN) and wide-area networks (WAN). LAN technologies include Fiber Distributed Data Interface (FDDI), Copper Distributed Data Interface (CDDI), Ethernet, Token Ring and the like. WAN technologies include, but are not limited to, point-to-point links, circuit switching networks like Integrated Services Digital Networks (ISDN) and variations thereon, packet switching networks, and Digital Subscriber Lines (DSL).

Communication connection(s) 750 refers to the hardware/software employed to connect the network interface 748 to the bus 718. While communication connection 750 is shown for illustrative clarity inside computer 712, it can also be external to computer 712. The hardware/software necessary for connection to the network interface 748 includes, for exemplary purposes only, internal and external technologies such as, modems including regular telephone grade modems, cable modems and DSL modems, ISDN adapters, and Ethernet cards.

In one exemplary aspect, recommendations can be provided as disclosed in U.S. patent application Ser. No. 12/237,864, “RECOMMENDATION GENERATION SYSTEMS, APPARATUS AND METHODS” to O'Donoghue et al., filed Sep. 25, 2008, published as Publ. No. 20090163183 A1 on Jun. 25, 2009, which claimed priority to Provisional Application No. 60/997,570 of the same title filed Oct. 4, 2007, both assigned to the assignee hereof and hereby expressly incorporated by reference herein.

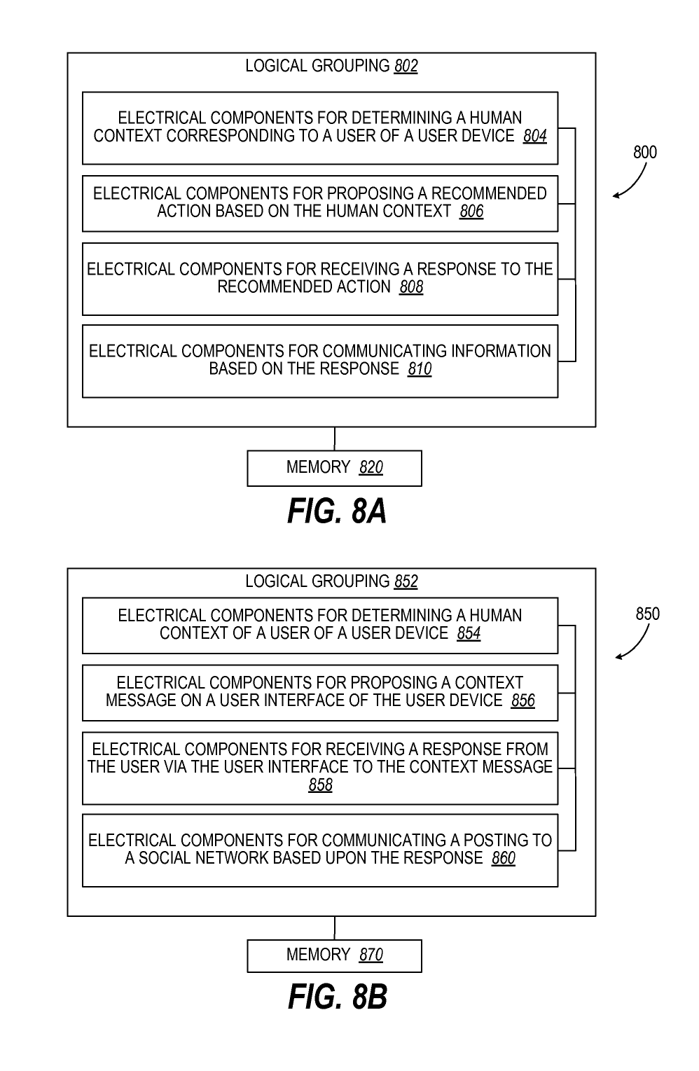

With reference to FIG. 8A, illustrated is a system 800 for recommending an action to a user. For example, system 800 can reside at least partially within user equipment (UE). It is to be appreciated that system 800 is represented as including functional blocks, which can be functional blocks that represent functions implemented by a computing platform, processor, software, or combination thereof (e.g., firmware). System 800 includes a logical grouping 802 of electrical components that can act in conjunction. For instance, logical grouping 802 can include an electrical component for determining a human context corresponding to a user of a user device 804. Moreover, logical grouping 802 can include an electrical component for proposing a recommended action based on the human context 806. For another instance, logical grouping 802 can include an electrical component for receiving a response to the recommended action 808. For an additional instance, logical grouping 802 can include an electrical component for communicating information based upon the response 810. Additionally, system 800 can include a memory 820 that retains instructions for executing functions associated with electrical components 804-810. While shown as being external to memory 820, it is to be understood that one or more of electrical components 804-810 can exist within memory 820.

With reference to FIG. 8B, illustrated is a system 850 for harvesting contextual information from users by use of computer-assisted social blogging in order to improve real-time recommendations, according to one aspect. For example, system 850 can reside at least partially within user equipment (UE). It is to be appreciated that system 850 is represented as including functional blocks, which can be functional blocks that represent functions implemented by a computing platform, processor, software, or combination thereof (e.g., firmware). System 850 includes a logical grouping 852 of electrical components that can act in conjunction. For instance, logical grouping 852 can include an electrical component for determining a human context of a user of a user device 854. Moreover, logical grouping 852 can include an electrical component for proposing a context message on a user interface of the user device 856. For another instance, logical grouping 852 can include an electrical component for receiving a response from the user via the user interface to the context message 858. For an additional instance, logical grouping 852 can include an electrical component for communicating a posting to a social network based upon the response 860. Additionally, system 850 can include a memory 870 that retains instructions for executing functions associated with electrical components 854-860. While shown as being external to memory 870, it is to be understood that one or more of electrical components 854-860 can exist within memory 870.

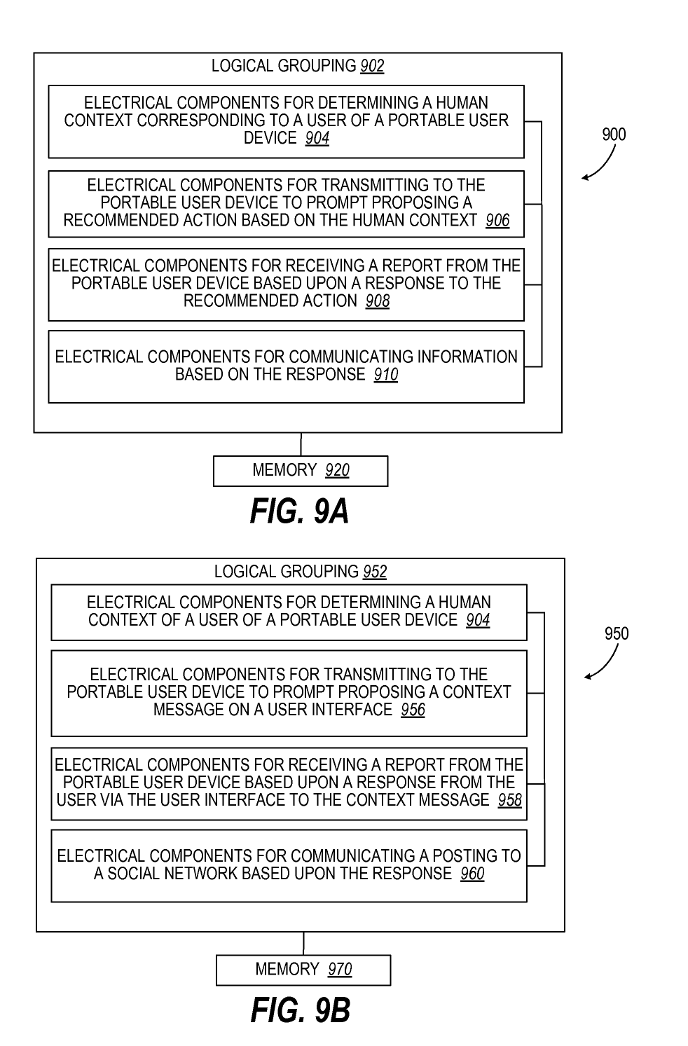

With reference to FIG. 9A, illustrated is a system 900 for recommending an action to a user. For example, system 900 can reside at least partially within a network entity. It is to be appreciated that system 900 is represented as including functional blocks, which can be functional blocks that represent functions implemented by a computing platform, processor, software, or combination thereof (e.g., firmware). System 900 includes a logical grouping 902 of electrical components that can act in conjunction. For instance, logical grouping 902 can include an electrical component for determining a human context corresponding to a user of a portable user device 904. Moreover, logical grouping 902 can include an electrical component for transmitting to the portable user device to prompt proposing a recommended action based on the human context 906. For another instance, logical grouping 902 can include an electrical component for receiving a report from the portable user device based upon a response to the recommended action 908. For an additional instance, logical grouping 902 can include an electrical component for communicating information based upon the response 910. Additionally, system 900 can include a memory 920 that retains instructions for executing functions associated with electrical components 904-910. While shown as being external to memory 920, it is to be understood that one or more of electrical components 904-910 can exist within memory 920.

With reference to FIG. 9B, illustrated is a system 950 for harvesting contextual information from users by use of computer-assisted social blogging in order to improve real-time recommendations. For example, system 950 can reside at least partially within a network entity. It is to be appreciated that system 950 is represented as including functional blocks, which can be functional blocks that represent functions implemented by a computing platform, processor, software, or combination thereof (e.g., firmware). System 950 includes a logical grouping 952 of electrical components that can act in conjunction. For instance, logical grouping 952 can include an electrical component for determining a human context of a user of a portable user device 954. Moreover, logical grouping 952 can include an electrical component for transmitting to the portable user device to prompt proposing a context message on a user interface 956. For another instance, logical grouping 952 can include an electrical component for receiving a report from the portable user device based upon a response from the user via the user interface to the context message 958. For an additional instance, logical grouping 952 can include an electrical component for communicating a posting to a social network based upon the response 960. Additionally, system 950 can include a memory 970 that retains instructions for executing functions associated with electrical components 954-960. While shown as being external to memory 970, it is to be understood that one or more of electrical components 954-960 can exist within memory 970.

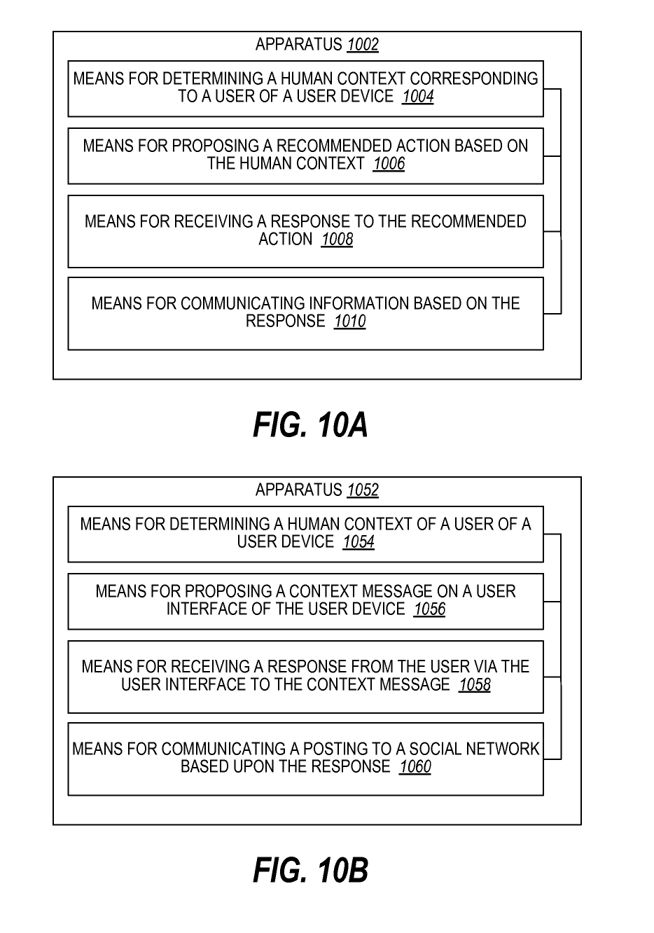

In FIG. 10A, an apparatus 1002 is depicted for recommending an action to a user. Means 1004 are provided for determining a human context of a user of a user device. Means 1006 are provided for proposing a recommended action based on the human context. Means 1008 are provided for receiving a response to the recommended action. Means 1010 are provided for communicating information based upon the response.

In FIG. 10B, an apparatus 1052 is depicted for harvesting contextual information from users by use of computer-assisted social blogging in order to improve real-time recommendations. Means 1054 are provided for determining a human context of a user of a user device. Means 1056 are provided for proposing a context message on a user interface of the user device. Means 1058 are provided for receiving a response from the user via the user interface to the context message. Means 1060 are provided for communicating a posting to a social network based upon the response.

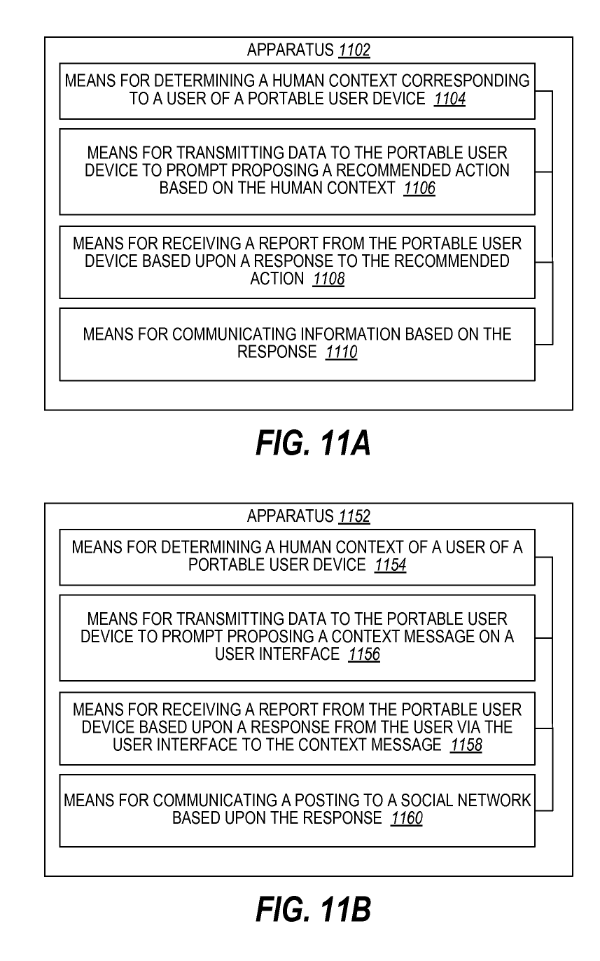

In FIG. 11A, an apparatus 1102 is depicted for recommending an action to a user. Means 1104 are provided for determining a human context corresponding to a user of a portable user device. Means 1106 are provided for transmitting data to the portable user device to prompt proposing a recommended action based on the human context. Means 1108 are provided for receiving a report from the portable user device based upon a response to the recommended action. Means 1110 are provided for communicating information based upon the response.

In FIG. 11B, an apparatus 1152 is depicted for harvesting contextual information from users by use of computer-assisted social blogging in order to improve real-time recommendations. Means 1154 are provided for determining a human context of a user of a portable user device. Means 1156 are provided for transmitting data to the portable user device to prompt proposing a context message on a user interface. Means 1158 are provided for receiving a report from the portable user device based upon a response from the user via the user interface to the context message. Means 1160 are provided for communicating a posting to a social network based upon the response.

Variations, modification, and other implementations of what is described herein will occur to those of ordinary skill in the art without departing from the spirit and scope of the disclosure as claimed. Accordingly, the disclosure is to be defined not by the preceding illustrative description but instead by the spirit and scope of the following claims.

What is claimed is:

1. A method for recommending an action to a user, comprising:
determining a human context corresponding to a user of a user device;
proposing a recommended action based on the human context;
receiving a response to the recommended action; and
communicating information based upon the response.

2. The method of claim 1, further comprising:
associating a third party with the user;
accessing a corresponding human context for the third party; and
determining the human context for the user based upon the corresponding human context for the third party.

3. The method of claim 1, further comprising:
proposing the recommended action by presenting a context message on a user interface of the user device;
receiving the response from the user via the user interface to the context message; and
communicating a posting to a social network based upon the response.

4. The method of claim 1, further comprising updating a profile of the user based upon the response from the user.

5. The method of claim 4, further comprising:
reporting contextual data to a network that maintains the profile of the user remote to the user device.

6. The method of claim 5, further comprising receiving the context message from the network.

7. The method of claim 5, further comprising receiving a transaction offer to present to the user via the user interface from the network based upon the profile, contextual message, and the response.

8. The method of claim 3, further comprising:
recommending a transaction offer related to the human context and the response; and
presenting the transaction offer on the user interface.

9. The method of claim 3, further comprising receiving a confirmation as the response to the context message.

10. The method of claim 9, further comprising:
proposing a plurality of context messages on the user interface of the user device;
receiving a confirmation of a selected one of the plurality of context messages; and
communicating the posting to the social network based on the selected one of the plurality of context messages.

11. The method of claim 9, further comprising filtering the posting prior to communicating to the social network.

12. The method of claim 11, further comprising determining the social network for receiving the posting.

13. The method of claim 12, further comprising:
accessing a constraint for communicating the posting to the social network; and
formatting the posting in accordance with the constraint.

14. The method of claim 3, further comprising:
determining a location of the user device; and
determining the human context based upon the location.

15. The method of claim 14, further comprising identifying the transaction offer based upon the location of the user device.

16. The method of claim 3, further comprising:
proposing a recommended action based on the human context related to a purchase transaction;
receiving the confirmation of the context messages to execute the purchase transaction; and
communicating the posting to the social network based upon the purchase transaction.

17. The method of claim 3, wherein the user device comprises a wireless device.

18. A computer program product for recommending an action to a user, comprising:
a computer-readable storage medium, comprising:
at least one instruction for causing a computer to determine a human context corresponding to a user of a user device;
at least one instruction for causing the computer to propose a recommended action based on the human context;
at least one instruction for causing the computer to receive a response to the recommended action; and
at least one instruction for causing the computer to communicate information based upon the response.

19. The computer program product of claim 18, further comprising:
at least one instruction for causing the computer to associate a third party with the user;
at least one instruction for causing the computer to access a corresponding human context for the third party; and
at least one instruction for causing the computer to determine the human context for the user based upon the corresponding human context for the third party.

20. The computer program product of claim 18, further comprising:
at least one instruction for causing the computer to propose the recommended action by presenting a context message on a user interface of the user device;
at least one instruction for causing the computer to receive the response from the user via the user interface to the context message; and
at least one instruction for causing the computer to communicate a posting to a social network based upon the response.

21. An apparatus for recommending an action to a user, comprising:
means for determining a human context corresponding to a user of a user device;
means for proposing a recommended action based on the human context;
means for receiving a response to the recommended action; and
means for communicating information based upon the response.

22. The apparatus of claim 21, further comprising:
means for associating a third party with the user;
means for accessing a corresponding human context for the third party; and
means for determining the human context for the user based upon the corresponding human context for the third party.

23. The apparatus of claim 21, further comprising:
means for proposing the recommended action by presenting a context message on a user interface of the user device;
means for receiving the response from the user via the user interface to the context message; and
means for communicating a posting to a social network based upon the response.

24. An apparatus for recommending an action to a user, comprising:
a user interface of a user device;
a computing platform for determining a human context corresponding to a user of the user device and for proposing a recommended action based on the human context, wherein the user interface is further for receiving a response to the recommended action; and
a network interface for communicating information based upon the response.

25. The apparatus of claim 24, wherein the computing platform is further for:
associating a third party with the user;
accessing a corresponding human context for the third party; and
determining the human context for the user based upon the corresponding human context for the third party.

26. The apparatus of claim 24, wherein the computing platform is further for proposing the recommended action by presenting a context message on a user interface of the user device, the user interface is further for receiving the response from the user via the user interface to the context message, and the network interface is further for communicating a posting to a social network based upon the response.

27. The apparatus of claim 26, wherein the computing platform is further for updating a profile of the user based upon the response from the user.

28. The apparatus of claim 27, further comprising a transmitter for reporting contextual data to a network that maintains the profile of the user remote to the user device.

29. The apparatus of claim 28, further comprising a receiver for receiving the context message from the network.

30. The apparatus of claim 28, further comprising a receiver for receiving a transaction offer to present to the user via the user interface from the network based upon the profile, contextual message, and the response.

31. The apparatus of claim 26, wherein the computing platform is further for recommending a transaction offer related to the human context and the response, and the user interface is further for presenting the transaction offer on the user interface.

32. The apparatus of claim 26, wherein the user interface is further for receiving a confirmation as the response to the context message.

33. The apparatus of claim 32, wherein the computing platform is further for proposing a plurality of context messages on the user interface of the user device, the user interface is further for receiving a confirmation of a selected one of the plurality of context messages, and the network interface is further for communicating the posting to the social network based on the selected one of the plurality of context messages.

34. The apparatus of claim 32, wherein the computing platform is further for filtering the posting prior to communicating to the social network.

35. The apparatus of claim 34, wherein the computing platform is further for determining the social network for receiving the posting.

36. The apparatus of claim 35, wherein the computing platform is further for accessing a constraint for communicating the posting to the social network and for formatting the posting in accordance with the constraint.

37. The apparatus of claim 26, wherein the computing platform is further for determining a location of the user device and for determining the human context based upon the location.

38. The apparatus of claim 37, wherein the computing platform is further for identifying the transaction offer based upon the location of the user device.

39. The apparatus of claim 26, wherein the computing platform is further for proposing a recommended action based on the human context related to a purchase transaction, the user interface is further for receiving the confirmation of the context messages to execute the purchase transaction, and the network interface is further for communicating the posting to the social network based upon the purchase transaction.

40. The apparatus of claim 26, wherein the user device comprises a wireless device.

41. A method for recommending an action to a user, comprising:
determining a human context corresponding to a user of a portable user device;
transmitting data to the portable user device to prompt proposing a recommended action based on the human context;
receiving a report from the portable user device based upon a response to the recommended action; and
communicating information based upon the response.

42. The method of claim 41, further comprising:
associating a third party with the user;
accessing a corresponding human context for the third party; and
determining the human context for the user based upon the corresponding human context for the third party.

43. The method of claim 41, further comprising:
proposing the recommended action by presenting a context message on a user interface of the user device;
receiving the response from the user via the user interface to the context message; and
communicating a posting to a social network based upon the response.

44. The method of claim 43, further comprising updating a profile of the user based upon the response from the user.

45. The method of claim 44, further comprising receiving a report of contextual data from the portable user device.

46. The method of claim 45, further comprising receiving the context message regarding usage selections made via the portable user device.

47. The method of claim 45, wherein transmitting the data further comprises transmitting a transaction offer to present to the user via the user interface based upon the profile, contextual message, and the response.

48. The method of claim 43, wherein transmitting the data further comprises transmitting a transaction offer related to the human context and the response to prompt the portable user device to present the transaction offer on the user interface.

49. The method of claim 43, wherein transmitting the data further comprises transmitting a plurality of transaction offers for selection by the portable user device in response to the human context and the response.

50. The method of claim 43, further comprising receiving a confirmation as the response to the context message.

51. The method of claim 50, further comprising:
transmitting a plurality of context messages to the portable user device for proposing on the user interface;
receiving a confirmation of a selected one of the plurality of context messages; and
communicating the posting to the social network based on the selected one of the plurality of context messages.

52. The method of claim 50, further comprising filtering the posting prior to communicating to the social network.

53. The method of claim 52, further comprising determining the social network for receiving the posting.

54. The method of claim 53, further comprising:
accessing a constraint for communicating the posting to the social network; and
formatting the posting in accordance with the constraint.

55. The method of claim 43, further comprising:
determining a location of the portable user device; and
determining the human context based upon the location.

56. The method of claim 55, further comprising identifying the transaction offer based upon the location of the portable user device.

57. A computer program product for recommending an action to a user, comprising:
a computer-readable storage medium, comprising:
at least one instruction for causing a computer to determine a human context corresponding to a user of a portable user device;
at least one instruction for causing the computer to transmit data to the portable user device to prompt proposing a recommended action based on the human context;
at least one instruction for causing the computer to receive a report from the portable user device based upon a response to the recommended action; and
at least one instruction for causing the computer to communicate information based upon the response.

58. The computer program product of claim 57, further comprising:
at least one instruction for causing the computer to associate a third party with the user;
at least one instruction for causing the computer to access a corresponding human context for the third party; and
at least one instruction for causing the computer to determine the human context for the user based upon the corresponding human context for the third party.

59. The computer program product of claim 57, further comprising:
at least one instruction for causing the computer to propose the recommended action by presenting a context message on a user interface of the user device;
at least one instruction for causing the computer to receive the response from the user via the user interface to the context message; and
at least one instruction for causing the computer to communicate a posting to a social network based upon the response.

60. An apparatus for recommending an action to a user, comprising:
means for determining a human context corresponding to a user of a portable user device;
means for transmitting data to the portable user device to prompt proposing a recommended action based on the human context;
means for receiving a report from the portable user device based upon a response to the recommended action; and
means for communicating information based upon the response.

61. The apparatus of claim 60, further comprising:
means for associating a third party with the user;
means for accessing a corresponding human context for the third party; and
means for determining the human context for the user based upon the corresponding human context for the third party.

62. The apparatus of claim 60, further comprising:
means for proposing the recommended action by presenting a context message on a user interface of the user device;
means for receiving the response from the user via the user interface to the context message; and
means for communicating a posting to a social network based upon the response.

63. An apparatus for recommending an action to a user, comprising:
a computing platform for determining a human context corresponding to a user of a portable user device;
a transmitter for transmitting data to the portable user device to prompt proposing a recommended action based on the human context;
a receiver for receiving a report from the portable user device based upon a response to the recommended action; and
a network interface for communicating information based upon the response.

64. The apparatus of claim 63, wherein the computing platform is further for
associating a third party with the user;
accessing a corresponding human context for the third party; and
determining the human context for the user based upon the corresponding human context for the third party.

65. The apparatus of claim 63, wherein the transmitter is further for transmitting to the portable user device to prompt proposing the recommended action by presenting a context message on a user interface of the user device;
the receiver is further for receiving the response from the user via the user interface to the context message; and
the network interface is further for communicating a posting to a social network based upon the response.

66. The apparatus of claim 65, wherein the computing platform is further for updating a profile of the user based upon the response from the user.

67. The apparatus of claim 66, wherein the receiver is further for receiving a report of contextual data from the portable user device.

68. The apparatus of claim 67, wherein the receiver is further for receiving the context message regarding usage selections made via the portable user device.

69. The apparatus of claim 67, wherein the transmitter is further for transmitting a transaction offer to present to the user via the user interface based upon the profile, contextual message, and the response.

70. The apparatus of claim 65, wherein the transmitter is further for transmitting a transaction offer related to the human context and the response to prompt the portable user device to present the transaction offer on the user interface.

71. The apparatus of claim 65, wherein the transmitter is further for transmitting a plurality of transaction offers for selection by the portable user device in response to the human context and the response.

72. The apparatus of claim 65, wherein the receiver is further for receiving a confirmation as the response to the context message.

73. The apparatus of claim 72, wherein the transmitter is further for transmitting a plurality of context messages to the portable user device for proposing on the user interface, wherein the receiver is further for receiving a confirmation of a selected one of the plurality of context messages, and
wherein the network interface is further for communicating the posting to the social network based on the selected one of the plurality of context messages.

74. The apparatus of claim 72, wherein the computing platform is further for filtering the posting prior to communicating to the social network.

75. The apparatus of claim 74, wherein the computing platform is further for determining the social network for receiving the posting.

76. The apparatus of claim 65, wherein the computing platform is further for accessing a constraint for communicating the posting to the social network, and for formatting the posting in accordance with the constraint.

77. The apparatus of claim 65, wherein the computing platform is further for determining a location of the portable user device and for determining the human context based upon the location.

78. The apparatus of claim 77, wherein the computing platform is further for identifying the transaction offer based upon the location of the portable user device.

79. At least one processor for recommending an action to a user, comprising:
a module for determining a human context corresponding to a user of a user device;
a module for proposing a recommended action based on the human context;
a module for receiving a response to the recommended action; and
a module for communicating information based upon the response.

80. The at least one processor of claim 79, further comprising:
a module for associating a third party with the user;
a module for accessing a corresponding human context for the third party; and
a module for determining the human context for the user based upon the corresponding human context for the third party.

81. The at least one processor of claim 79, further comprising:
a module for proposing the recommended action by presenting a context message on a user interface of the user device;
a module for receiving the response from the user via the user interface to the context message; and
a module for communicating a posting to a social network based upon the response.

82. At least one processor for recommending an action to a user, comprising:
a module for determining a human context corresponding to a user of a portable user device;
a module for transmitting data to the portable user device to prompt proposing a recommended action based on the human context;
a module for receiving a report from the portable user device based upon a response to the recommended action; and
a module for communicating information based upon the response.

83. The at least one processor of claim 82, further comprising:
a module for associating a third party with the user;
a module for accessing a corresponding human context for the third party; and
a module for determining the human context for the user based upon the corresponding human context for the third party.

84. The at least one processor of claim 82, further comprising:
a module for proposing the recommended action by presenting a context message on a user interface of the user device;
a module for receiving the response from the user via the user interface to the context message; and
a module for communicating a posting to a social network based upon the response.
